(19) United States
(12) Patent Application Publication
(10) Pub. No.: US 2013/0152755 A1
(43) Pub. Date: Jun. 20, 2013

(54) HOLDING SHEET AND CUTTING APPARATUS

(71) Applicant: Brother Kogyo Kabushiki Kaisha, Nagoya-shi (JP)

(72) Inventors: Katsuhisa Hasegawa, Nagoya-shi (JP); Yasuhiko Kawaguchi, Nagoya-shi (JP); Masahiko Nagai, Nagoya-shi (JP); Tomoyasu Niizeki, Nagoya-shi (JP)

(73) Assignee: BROTHER KOGYO KABUSHIKI KAISHA, Nagoya-shi (JP)

(21) Appl. No.: 13/719,882

(22) Filed: Dec. 19, 2012

(30) Foreign Application Priority Data
Dec. 20, 2011 (JP) 2011-278231

(51) Int. Cl. B26D 7/01

(52) U.S. Cl. CPC B26D 7/015
USPC 83/451; 269/289 R

(57) ABSTRACT

A holding sheet may comprise an adhesive portion disposed on at least a part of either one of surfaces of the holding sheet. The adhesive portion may be configured to attach to a workpiece. The holding sheet may also comprise a removable sheet configured to be attached to the adhesive portion. The holding sheet may comprise a locator disposed on at least either the holding sheet or the removable sheet, and configured to attach the removable sheet to the adhesive portion in a predetermined location.

### CROSS-REFERENCE TO RELATED APPLICATION

This application is based upon and claims the benefit of priority from the prior Japanese Patent Application 2011-278231, filed on, Dec. 20, 2011, the entire contents of which are incorporated herein by reference.

### BACKGROUND

Conventionally, a cutting plotter is known. The cutting plotter cuts, for example, a paper sheet. The paper sheet is attached to a base material. The base material comprises an adhesive portion in a surface of the base material. For example, the base material, for example is a holding sheet. The cutting plotter comprises a drive roller and a pinch roller. The drive roller and pinch roller pinch a left side and right side edge of the base material between top and bottom, and let the base material move toward a first direction. The cutting plotter cuts the paper sheet by letting a carriage move toward a second direction which is a vertical direction of the first direction. The carriage comprises a cutter.

Generally, the base material which is used by the above-mentioned type of the cutting plotter comprises a removable sheet which covers a surface of an adhesive layer. A user of the cutting plotter peels off the removable sheet from the adhesive layer, when the user uses the base material. After the user finishes using the base material, the user attaches the removable sheet to the adhesive layer again. Like this, the base material and removable sheet are used repeatedly.

The user may unintentionally touch the adhesive layer, if the adhesive layer is left exposed. Moreover, in this case, adhesive power of the adhesive layer is lowered, because dust is attached to the adhesive layer. Accordingly, the user has to attach the removable sheet to the adhesive layer as fitting an edge of the adhesive layer and an edge of the removable sheet in order not to expose the adhesive layer, when the user does not use the base material. In this case, it is troublesome for the user not to touch the surface of the adhesive layer and to attach the removable sheet to the adhesive layer accurately.

### SUMMARY

Various exemplary embodiments of the general principles herein may provide a holding sheet comprises an adhesive portion disposed on at least a part of either one of surfaces of the holding sheet, wherein the adhesive portion is configured to attach to a workplace. The holding sheet may also comprise a removable sheet configured to be attached to the adhesive portion. The holding sheet may also comprise a locator disposed on either the holding sheet or the removable sheet, and configured to attach the removable sheet to the adhesive portion in a predetermined location.

Exemplary embodiments herein may provide a cutting apparatus which may comprise a cutter configured to cut a workpiece, and a holding sheet. The holding sheet may also comprise an adhesive portion disposed on at least a part of either one of surfaces of the holding sheet, wherein the adhesive portion is configured to attach to a workpiece. The holding sheet may also comprise a removable sheet configured to be attached to the adhesive portion. The holding sheet may also comprise a locator disposed on at least either the holding sheet or the removable sheet, and configured to attach the removable sheet to the adhesive portion in a predetermined location.

### BRIEF DESCRIPTION OF THE DRAWINGS

FIG. 1 is an example of a perspective illustration, showing an inner structure of a cutting apparatus and a holding sheet according to a first embodiment;

FIG. 2 is an example of an enlarged illustration, showing a tip of the cutter when a cutting apparatus cuts a workplace according to a first embodiment;

FIG. 3A is an example of a plain view of a holding sheet according to a first embodiment;

FIG. 3B is an example of a side view of a holding sheet according to a first embodiment;

FIG. 3C is an example of a cross sectional view along with a IIIc-IIIc line of FIG. 3A according to a first embodiment;

FIG. 4 is an example of a plain view of a removable sheet according to a first embodiment;

FIGS. 5A and 5B are examples of plain views of disposition of the removable sheet, when the holding sheet is used and not used according to a first embodiment;

FIG. 6 is an example of a removable sheet according to a second embodiment;

FIG. 7A is an example of a plain view of a holding sheet according to a third embodiment;

FIG. 7B is an example of a side view of a holding sheet according to a third embodiment;

FIG. 7c is an example of a plain view, showing that a removable sheet is attached to a holding sheet according to a third embodiment;

FIG. 8 is an example of an example of a plain view, showing that a removable sheet is attached to a holding sheet according to a fourth embodiment;

FIG. 9 is an example of a plain view of a removable sheet according to a fifth embodiment;

FIG. 10 is an example of a plain view of a removable sheet according to a sixth embodiment;

FIG. 11 is an example of a cross sectional view along with a IIIc-IIIc line of FIG. 3A according to a seventh embodiment.

### DETAILED DESCRIPTION

### First Embodiment

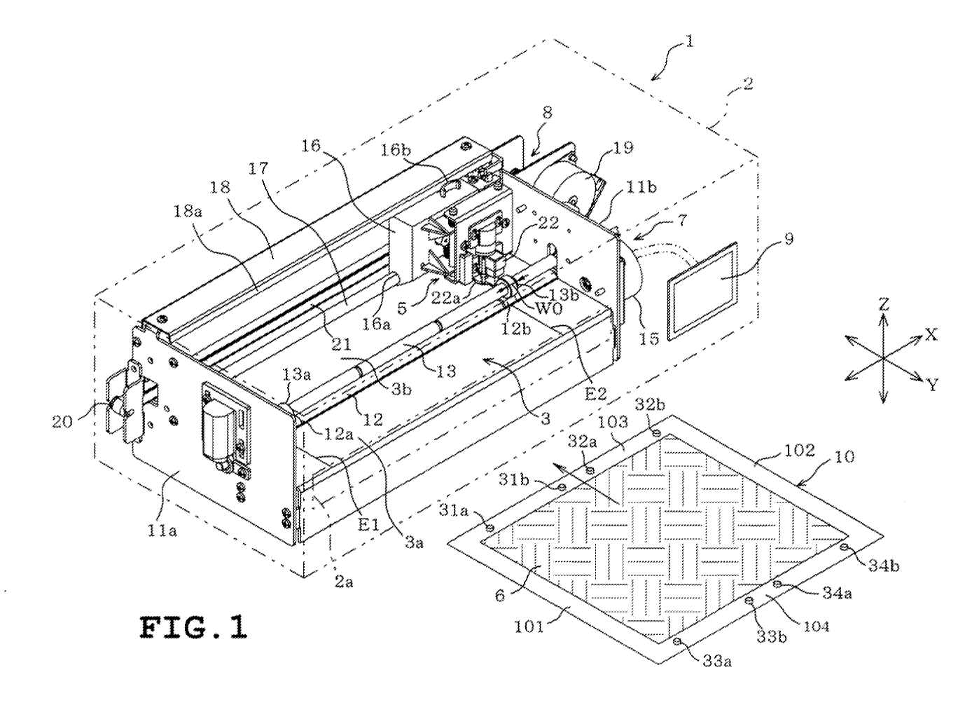

A first embodiment of the disclosure is described with reference to FIGS. 1 to 5B.

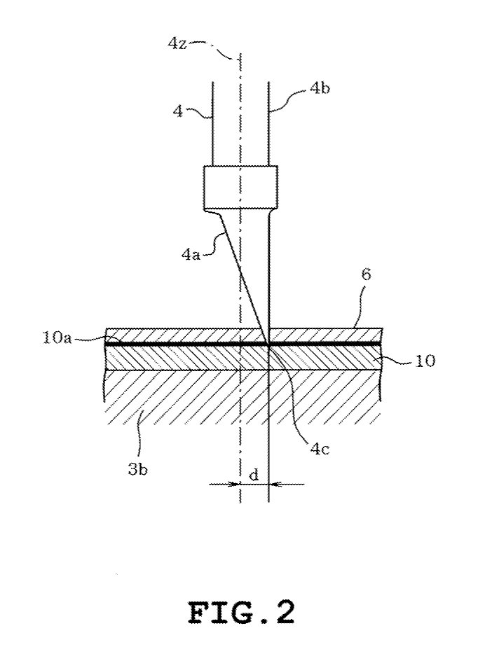

Referring to FIG. 1, a cutting apparatus 1 is provided with a main cover 2 serving as a housing, a platen 3 disposed inside the main cover 2, and a cutter holder 5. The cutter holder 5 holds a cutter 4 shown in FIG. 2. The cutting apparatus 1 is further provided with a first transfer unit 7 and a second transfer unit 8 for transferring the cutter 4 and a cutting workpiece 6, hereinafter simply referred to as workpiece 6, relative to one another. On the front face of the main cover 2, a laterally elongate opening 2a is formed to provide access to the platen 3. Through the opening 2a, a holding sheet 10 holding the workpiece 6 may be placed on the upper surface of the platen 3. Hereinafter, the direction in which the workpiece 6 is moved by the first transfer unit 7 is referred to as the front and rear direction. The direction toward the opening 2a is referred to as forward and the opposite direction, naturally, is rearward. The front and rear direction is further referred to as the Y direction and the left and right direction is further referred to as the X direction.

On the right side of the main cover 2, a liquid crystal display (LCD) 9 is provided which is one example of a display unit. Provided further on the right side of the main cover 2 is a plurality of control switches not shown which is controlled by the user for providing various instructions and making selections and inputs.

The platen 3 comprises a pair of front plate 3a and a rear plate 3b. The upper surface of the platen 3 is level and lies on an XY plane. The holding sheet 10 holding the workpiece 6 is placed on the platen 3 and is supported by the platen 3 while the workpiece 6 is being cut. As later described in detail, the upper surface of the holding sheet 10 includes an adhesive portion 10a which is formed by applying an adhesive on the area of the upper surface surrounded by peripheral edge portions 101 to 104. The user may stick or attach the workpiece 6 on the adhesive portion to allow the workpiece 6 to be held by the holding sheet 10.

On the front plate 3a of platen 3, reference lines E1 and E2 are provided, for instance, on the left and right sides. The spacing between the reference lines E1 and E2 are equal to or slightly greater than the width of the holding sheet 10. The width of the holding sheet 10, in this case, is taken along the left and right direction. The reference lines E1 and E2 are visible through the opening 2a and thus, serve as reference marks for determining the X-directional location of the holding sheet 10. The X direction is oriented in the width direction of the holding sheet 10. The pair of reference lines E1 and E2 is one example of a locator.

The first transfer unit 7 transfers the holding sheet 10 in the Y-direction across the upper surface of the platen 3. The Y-direction is also hereinafter referred to as the first direction. The first transfer unit 7 is primarily configured by a drive roller 12 and a pinch roller 13. The drive roller 12 and the pinch roller 13 extend across the left and right sidewalls 11a and 11b of the cutting apparatus 1 so as to be located between the front plate 3a and the rear plate 3b of the platen 3. Both the drive roller 12 and the pinch roller 13 extend in the left and right direction and are supported rotatably by the sidewalls 11a and 11b. The pinch roller 13 is disposed above the drive roller 12 such that when the holding sheet 10 is placed on the platen 3, the drive roller 12 resides below the holding sheet 10 whereas the pinch roller 13 resides above the holding sheet 10. The pinch roller 13 disposed above the drive roller 12 is biased toward the drive roller 12 by a compression coil spring not shown.

Though not shown in detail, the pinch roller 13 is provided with depressors 13a and 13b that contact and depress the left and right side edge portions 101 and 102 of the holding sheet 10. The outer diameters of depressors 13a and 13b are configured to be slightly larger than those of other portions of the pinch roller 13. The outer surfaces of the depressors 13a and 13b are knurled. The drive roller 12 similarly has knurled depressors 12a and 12b at locations corresponding to the depressors 13a and 13b.

On the outer side of right sidewall 11b, a Y-axis drive motor 15 and a first deceleration gear mechanism not shown are disposed that actuate the drive roller 12. Because of the above described bias exerted by the compression coil spring, the holding sheet 10 is held between the pinch roller 13 and the drive roller 12 so as to receive upward and downward pressure. When the Y-axis motor 15 is driven in the forward or reverse directions, the rotary motion is transmitted to the drive roller 12 by way of the first deceleration gear mechanism. The actuation of the drive roller 12 feeds the holding sheet 10 and the workplace 6 forward or rearward. The drive roller 12, the pinch roller 13, the Y-axis motor 15, the first deceleration gear mechanism, and the compression coil spring constitute the first transfer unit 7.

The second transfer unit 8 transfers the carriage 16 for holding the cutter holder 5 in the X direction which is hereinafter also referred to as a second direction. More specifically, between the rear end portions of the left and right sidewalls 11a and 11b, a guide shaft 17 and a guide frame 18 are disposed so as to extend in the left and right direction. The guide shaft 17 is located immediately above the platen 3 and extends through the lower portion of the carriage, that is, through a later described through hole 16a. The guide frame 18 is secured on the upper end portions of the sidewalls 11a and 11b. The guide frame 18 has a downwardly bending front edge 18a. The carriage 16 is guided by the front edge 18a by way of a later described guide subject 16b.

On the rear portion of the cutting apparatus 1, an X-axis motor 19 and a second deceleration gear mechanism not shown is disposed on the outer side of the right sidewall 11b. The second deceleration gear mechanism is provided with a pulley not shown. Outside the left sidewall 11a, pulley 20 is mounted rotatably. The pulley of the second deceleration gear and the pulley 20 are wound with a timing belt 21. The timing belt 21 is an endless timing belt connected to the rear end, that is, a later described mounting portion of the carriage 16.

When the X-axis motor 19 is driven forward or rearward, the rotary motion is transmitted to the timing pulley by way of the second deceleration gear mechanism and the pulley. The carriage 16 as well as the cutter holder 5 are thus, transferred in the left and right direction. The carriage 16 and the cutter holder 5 are transferred in the Y direction and the X direction orthogonal to the Y direction in which the workpiece 6 is carried by the above described arrangement. The guide shaft 17, the guide frame 18, the X-axis motor 19, and the second gear deceleration gear mechanism, the timing belt 21, the carriage 16, etc. constitute the second transfer unit 8.

The cutter holder 5 is disposed on the front side of the carriage 16 and is supported by the carriage 16 so as to be movable in the up and down direction, also referred to as the Z direction or a third direction hereinafter. The carriage 16 is configured substantially in the form a rectangular box which is oriented such that its opening faces rearward. On the upper wall of the carriage 16, the guide subject 16b is provided that clutches the front edge 18a of the guide frame 18. On the lower end portion of the carriage 16, the through hole 16a is formed for insertion of the guide shaft 17. Further, on the bottom wall of the carriage 16, a mounting portion not shown which is configured to be connected to the timing belt 21 is provided so as to protrude rearward. The carriage 16 is supported slidably in the left and right direction by the guide shaft 17 inserted into the through hole 16a. Because the guide subject 16b of the carriage 16 clutches the guide frame 18, the carriage 16 is inhibited from pivoting around the guide shaft 17.

Though not shown, a Z-axis motor is provided inside the carriage 16. Between the carriage 16 and the cutter holder 5, a third deceleration mechanism not shown is provided. The third deceleration mechanism is a transmission mechanism that decelerates the rotary motion of the Z-axis motor and that converts the rotary motion into an up and down movement of the cutter holder 5. When the Z-axis motor is driven forward or rearward, the rotary motion is converted into an up and down, movement by way of the transmission mechanism. The up and down movement causes lifting/lowering of the cutter holder 5 and the cutter 4 to the lifted/lowered position. The transmission mechanism and the Z-axis motor constitute the third transfer unit that transfers the cutter holder 5.

Inside the cutter holder 5, a cutter shaft 4b oriented in the Z-axis direction as shown in FIG. 2 is supported rotatably about an axis line 4z. More specifically, the cutter 4 is an integral structure comprising a round cutter shaft 4b and a blade 4a provided on the lower end of the cutter shaft 4b. As shown in FIG. 2, the blade 4a is substantially triangular. The blade 4a has a tip 4c on its lowermost end which is eccentric by spacing d form the central axis line 4z of the cutter shaft 4b. Thus, the tip 4c of the cutter 4 is depressed against the XY plane of the surface of the workpiece 6 from the direction Z orthogonal to the XY plane. Further, the height of the cutter 4 is configured such that the tip 4c passes through the workpiece 6 overlying the holding sheet 10 but does not reach the upper surface of the plate 3b of the platen 3 when the cutter holder 5 is moved to the lowered position. When the cutter holder 5 is moved to the lifted position, the blade 4c is also moved upward away from the workpiece 6.

The cutter holder 5 is provided with a presser device 22 for pressing the workpiece 6. Though not shown in detail, the presser device 22 is provided with a solenoid and a presser member 22a. The solenoid is mounted on the cutter holder 5 so as to face downward. The presser member 22a contacts the workpiece 6 at the periphery of the blade 4a. When the solenoid is driven when the cutter holder 5 is in the lowered position, the plunger of the solenoid is lowered with the presser member 22a to depress the workpiece 6 by a predetermined pressure. In contrast, when the solenoid is not driven, the plunger is located in an upper position and the pressure applied to the workpiece 6 by the presser member 22a is released.

Though not shown in detail, the cutting apparatus 1 is provided with a controller responsible for overall control of the apparatus and a storage device that stores cut data later described in detail. The controller controls the various types of actuators such as the Y-axis motor 15, the X-axis motor 19, the Z-axis motor, and the solenoid through execution of a cut control program. The controller, thus, automatically cuts the workpiece 6 overlying the holding sheet 10.

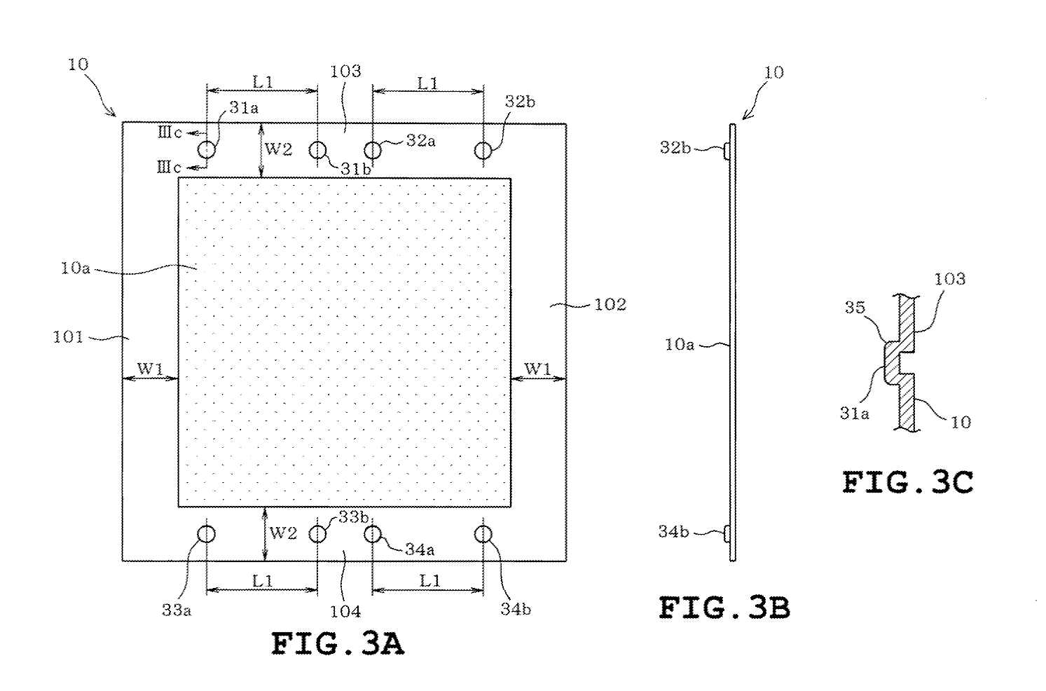

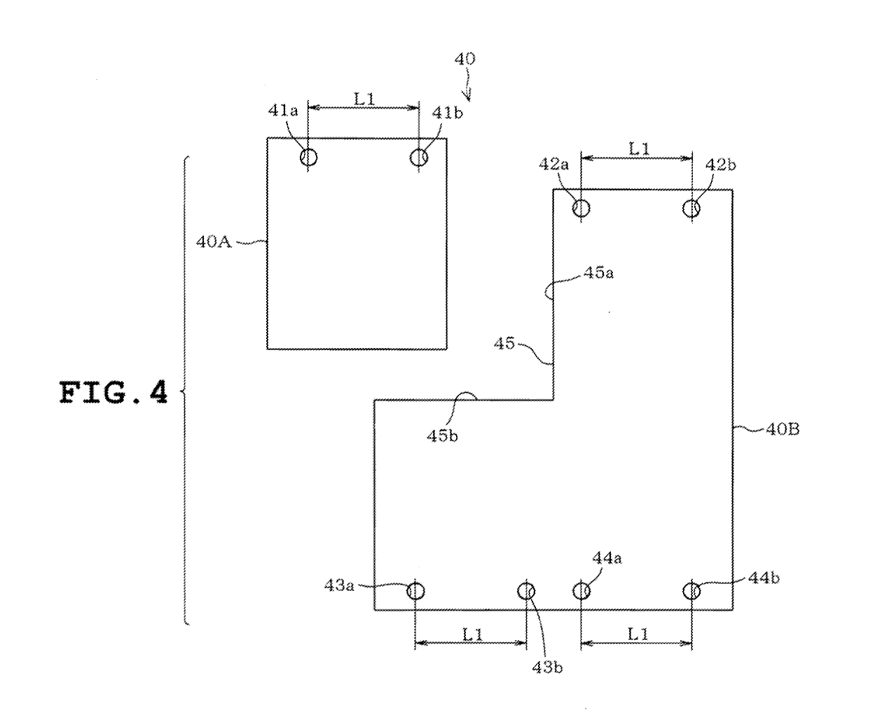

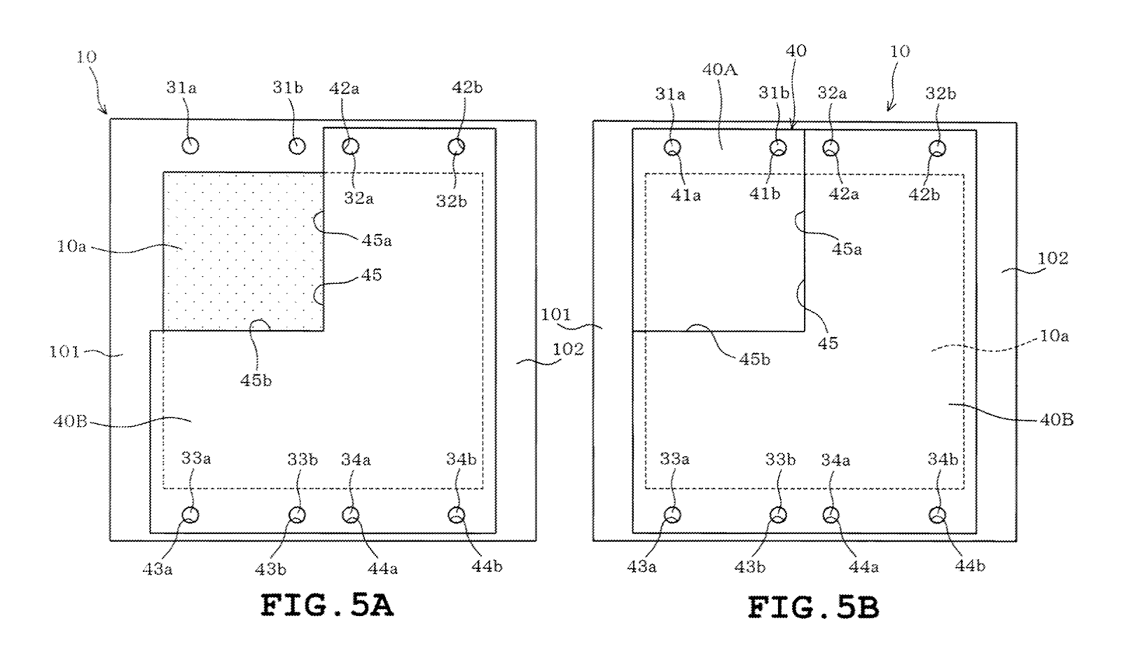

The holding sheet 10 is provided with a removable sheet 40 that covers the surface of the adhesive portion 10a as shown in FIGS. 4, and 5B. In the first embodiment, the holding sheet 10 is provided with a locator for locating the removable sheet 40 with the adhesive portion 10a when applying the removable sheet 40 on the adhesive portion 10a. The locator facilitates the attachment of the removable sheet 40 to the predetermined location of the adhesive portion 10a. The configuration of the holding sheet 10 will be described in detail with reference to FIGS. 3A to 3C.

The holding sheet 10 comprises a flat holding member taking a substantially square shape in plan view as can be seen in FIG. 3A. The holding sheet 10 is made of a resin material such as polypropylene possessing relatively high rigidity. The holding sheet 10 is provided with an adhesive portion 10a on its upper surface opposing the cutter 4.

The adhesive portion 10a is formed in an area within the holding sheet 10 which is spaced inward by a predetermined distance, indicated as W1 and W2 in FIG. 3A, from the outer edge of the holding sheet 10. As shown in FIG. 2, the adhesive portion 10a is substantially square in plan view and comprises a sticky layer of adhesive agent. The adhesive layer 10a allows the holding sheet 10 to removably hold various types of workpiece 6. The adhesive force of the adhesive portion 10a is controlled to a relatively weak level to allow the workpiece 6 to peel easily without ripping. The holding sheet 10 and the adhesive portion 10a being substantially square in the first embodiment, may be rectangular. The site of the adhesive portion 10a may be modified as required as long as it is formed on at least a portion of the upper surface on one side of holding sheet 10.

On the peripheral edge of the holding sheet 10, a left edge portion 101, a right edge portion 102, a rear edge portion 103, and a front edge portion 104 are provided as areas free of the adhesive portion 10a. The left edge portion 101 and the right edge portion 102 each serves as a support subject being supported by the pressure applied by the upper pinch roller 13 and the lower drive roller 12. Width W1 of the left edge portion 101 and the right edge portion 102 is slightly greater than axial width W0 of the depressors 13a and 13b of the pinch roller 13 (W1>Wo). Width W2 of the rear edge portion 103 and the front edge portion 104 are equal to width W1 of the left edge portion 101 and the right edge portion 102 (W1=W2).

On the rear edge portion 103 and the front edge portion 104 of the holding sheet 10, a plurality of engagement protrusions 31a to 34b are provided to serve as the locators. More specifically, on the outer area of adhesive portion 10a provided in the holding sheet 10, 4 engagement protrusions 31a to 32b are aligned in the left and right direction along the rear edge of the adhesive portion 10a. Similarly, in the outer area of the adhesive portion 10a, 4 engagement protrusions 33a to 34b are aligned in the left and right direction along the front edge of the adhesive portion 10a. The engagement protrusions 31a to 34b are each formed in the shape of a small cylinder. These engagement protrusions 31a to 34b are emboss portions formed so as to protrude upward by emboss processing.

As shown in FIG. 3C, the ridges of the tips of the engagement protrusions 31a to 34b are provided with a chamfered portion 35. The chamfered portion 35 allows smooth insertion of the engagement protrusions 31a to 34b into engagement holes 41a to 44b of removable sheet 40 shown in FIG. 4 later described in detail. The size of the engagement protrusions 31a to 34b is controlled to a relatively short length based on the diametric size of the depressors 13a and 13b of the pinch roller 13 and the thickness of the workpiece 6, etc.

The engagement protrusions 31a to 34b are arranged such that the adjacent engagement protrusions: 31a and 31b, 32a and 32b, 33a and 33b, and 34a and 34b each form a pair. The engagement protrusions within each pair are distanced from one another by a predetermined spacing L1 to establish an engagement with the engagement holes 41a and 41b of the removable sheet 40, or more specifically, a first partial sheet 40A later described in detail. The engagement holes 41a and 41b of the first partial sheet 40A selectively engages with either of the four pairs of engagement protrusions 31a and 31b, 32a and 32b, 33a and 33b, and 34a and 34b by the above described arrangement. Further, each of the engagement protrusions 31a to 34b is disposed on the holding sheet 10 so as to be symmetric in the left and right direction as well as the front and rear direction. Thus, the engagement protrusions 31a to 34b may engage with the engagement holes 41a to 44b even when the removable sheet 40 is turned so that the left and the right sides or the front and rear sides (the upper and lower sides as viewed in FIG. 4) are switched over.

Next, a description will be given on the removable sheet 40 with reference to FIGS. 4 to 5B. The removable sheet 40 protects the adhesive portion 10a from contact and attachment of unwanted substances such as dust in order to maintain the adhesive force of the adhesive portion 10a.

FIG. 5B shows the removable sheet 40 being attached to the adhesive portion 10a of the holding sheet 10. As shown, the removable sheet 40 is generally flat and rectangular. The removable sheet 40 is formed so as to be larger than the adhesive portion 10a. The removable sheet 40 may be formed, for example, by a transparent resin material with suitable rigidity such as PET (Polyethylene terephthalate). The surface of the removable sheet 40 is siliconized.

On the peripheral edge of the removable sheet 40, engagement holes 41a to 44b serving as locators are formed in the location corresponding to engagement protrusions 31a to 34b of the holding sheet 10. More specifically, on the rear edge portion of the removable sheet 40, 4 engagement holes 41a to 42a are formed with spacing equal to the spacing of the engagement protrusions 31a to 34b. Similarly, on the front edge portion of the removable sheet 40, 4 engagement holes 43a to 44a are formed with spacing equal to the spacing of the engagement protrusions 33a to 34b. The engagement holes 41a to 44b are small circular holes extending in the thickness direction through the removable sheet 40. Engagement holes 41a to 44b are engagement subjects engaging with the engagement protrusions 31a 34b inserted into them. Thus, the diametric dimensions of the engagement protrusions 41a to 44b are slightly larger than those of the engagement protrusions 31a to 34b.

The removable sheet 40 of the first embodiment are separable into the first partial sheet 40A and a second partial sheet 40B at a divisional line 45 shown in FIG. 4. The divisional line 45 is an L-shaped line configured by straight lines 45a and 45b intersecting at the center of the removable sheet 40. The straight line 45a is located in the widthwise center of the removable sheet 40. The width is taken along the left and right direction. The straight line 45b is located in the lengthwise center of the removable sheet 40. The length is taken along the front and rear direction. The straight lines 45a and 45b being orthogonal to one another delineate the left side of the removable sheet 40 into the front half and the rear half.

The first partial sheet 40A is a rectangular subsection delineated by the divisional line 45a and is ¼ the size or the area of the removable sheet 40. The first partial sheet 40A is provided with the engagement holes 41a and 41b on its rear edge portion. As shown in FIG. 5B, the engagement holes 41a and 41b of the first partial sheet 40A are engaged with the engagement protrusions 31a and 31b of the holding sheet 10 by the user to place the first partial sheet 40A in a first position in the left-side rear half portion of the holding sheet 10. Though not shown, the user may engage the engagement holes 41a and 41b of the first partial sheet 40A with the engagement protrusions 32a and 32b in the right side to place the first partial sheet 40A in a second position in the right-side rear half portion of the holding sheet 10.

Further, though not shown, the user may turn the first partial sheet 40A such that the front side and the rear side are switched over to place the engagement holes 41a and 41b in the front side. In this state, the first partial sheet 40A is engaged with the engagement protrusions 33a and 33b at the front side of the holding sheet 10 to place the holding sheet 10 in a third position in the left-side front half portion of the holding sheet 10. Similarly, the user may engage the turned first partial sheet 40A with the right side engagement protrusions 34a and 34b to place the first partial sheet 40A in a fourth position in the right-side front half portion of the holding sheet 10. Thus, by selectively engaging the pair of engagement holes 41a and 41b with either one of the pair of engagement protrusions 31a to 34b, 4 types of layout patterns may be established by placing the first partial sheet 40A in the first to fourth position with respect to the holding sheet 10.

The second partial sheet 40B is ¾ the size of the removable sheet 40 and is generally L-shaped. The second partial sheet 40B is provided with engagement holes 42a and 42b on its rear edge portion. As shown in FIG. 5A, the engagement holes 42a to 44b of the second partial sheet 40B are engaged with the engagement protrusions 32a to 34b of the holding sheet 10 by the user to place the second partial sheet 40B in a first position in which the left-side rear half portion of the holding sheet 10 is opened. The user may turn the second partial sheet 40B shown in FIG. 5A so that the left side and the right side are switched over. In this state, the engagement holes 42a and 44b of the second partial sheet 40B are engaged with the engagement protrusions 31a and 31b and 33a to 34b to place the second partial sheet 40B in a second position in which the right-side rear half portion of the holding sheet 10 is opened.

Further, the user may turn the second partial sheet 40B such that the front side and the rear side are switched over. In this state, the engagement holes 42a to 44b are engaged with the engagement protrusions 31a to 32b and 34a and 34b to place the second partial sheet 40B shown in FIG. 5A in a third position in which the left-side front half portion of the holding sheet 10 is opened. Similarly, the user may further turn the second partial sheet 40B so that left side and the right side are switched over. In this state, the engagement holes 42a to 44b are engaged with the engagement protrusions 31a to 33b to place the second partial sheet 40B in a fourth position in which the right-side front half portion of the holding sheet 10 is opened. Thus, by selectively engaging the 6 engagement holes 42a to 44b with either of the 6 engagement protrusions 31a to 34b, 4 types of layout patterns may be established by placing the second partial sheet 40B in the first to fourth position with respect to the holding sheet 10.

The removable sheet 40 comprising the combination of the first partial sheet 40A and the second partial sheet 40B is formed so as to be larger than the adhesive portion 10a as shown in FIG. 5B. Thus, the user may hold the peripheral edge of the removable sheet 40 which is not in adhesion with the adhesive portion 10a and peel the respective partial sheets 40A and 40B from the adhesive portion 10a without touching the adhesive portion 10a. The user may attach the respective partial sheets 40A and 40B on the adhesive portion 10a in the same way.

Next a description will be given on the operation of the above described configuration. Prior to the cutting operation with the cutting apparatus 1, the user is to prepare the cutting workpiece 6 and the holding sheet 10 for holding the workpiece 6. A typical workpiece 6 may be a sheet of paper, fabric, and resin film which are sized to fit within the holding sheet 10. The following description of the first embodiment exemplifies cutting out patterns from 2 types of workpiece 6 both comprising a square sheet varying in size. The first type of workpiece 6, hereinafter referred to as a small size workpiece, is ¼ the size of the adhesive portion 10a. The second type of workpiece 6 is the same in size with the adhesive portion 10a.

As shown in FIG. 5B, when the holding sheet 10 is not in use or stored, the first partial sheet 40A and the second partial sheet 40B are each attached to the adhesive portion 10a in the aforementioned first position. In this state, the first partial sheet 40A and the second partial sheet 40B take the appearance of a single piece of a rectangular removable sheet 40 covering the entire adhesive portion 10a without creating any gaps between them at the divisional line 45.

In case the user wishes to cut out a relatively small pattern based on cutting data using the cutting apparatus 1, the user is to peel the first partial sheet 40A from the holding sheet 10 as shown in FIG. 5A to expose the left side rear half portion of the adhesive portion 10a. Then, the small size workpiece is attached to the exposed area of the adhesive portion 10a to be held by the holding sheet 10. In this example, the size of the small size workpiece is the same as the size of the exposed area of the adhesive portion 10a. Thus, the user is allowed to attach the small size workpiece such that the adhesive portion 10a is not exposed and such that the attached workpiece does not go beyond the bounds of adhesive portion 10a.

Then, the holding sheet 10 is inserted through the opening 2a of the cutting apparatus 1 to be set within the cutting apparatus 1. At this instance, the user is to slide the holding sheet 10 rearward, in the direction of the arrow in FIG. 1, into the opening 2a, while adjusting the left and right corners of the holding sheet 10 to the reference lines E1 and E2. Thereafter, the left edge portion 101 and the right edge portion 102 are inserted and held between the depressors 12a to 13b of the drive roller 12 and pinch roller 13. Having set the holding sheet 10 into the cutting apparatus 1, the user is to operate the control switches to execute the cutting operation by, for instance, selecting the desired cutting data from the cut data stored in the storage device. Because the adhesive portion 10a is covered by the second partial sheet 40B and the small size workpiece, the adhesive portion 10a is protected from dust and debris of the cut workpiece. Further, the small size workpiece is attached so as to stay out of the edge portion 101 of the holding sheet 10. Thus, there will be no instances where the workpiece 6 located in the edge portions 101 and 102 of the holding sheet 10 is drawn into the pinch roller 13, and the holding sheet 10 can be reliably moved regardless of the thickness of the workpiece 6.

After completing the cutting of the workpiece, the user is to peel the workpiece from the holding sheet 10. In case the cutting is to further proceed with a relatively small workpiece, the user is to attach a new set of small size workpiece on the holding sheet 10 for cutting with the cutting apparatus 1. When such cutting work is repeated, adhesive force of the adhesive portion 10a will eventually weaken and fail to reliably to hold the workpiece. Because the adhesive force of the holding sheet 10 will degrade with the times of use, the use of the holder sheet 10 is normally limited, for instance, to 10 times. However, by switching the location of the second partial sheet 40B within the holding sheet 10, the times of use of the holding sheet 10 may be increased by 4 times. That is, whenever the upper limit of the times of use is encountered in one of the ¼ regions of the adhesive portion 10a to which the small size workpiece is attached, the second partial sheet 40B may be turned so as to switch over the left and the right side or the front and the rear side to change the layout of the holding sheet 10 in the sequence of the first position, the second position, the third position, and the fourth position.

In case a pattern is to be cut out from the workpiece 6 which is the same in size with the adhesive portion 10a, the user is to further peel the second partial sheet 40B from the holding sheet 10 as shown in FIG. 3A. The workpiece 6 is attached to the holding sheet 10 so as to cover the adhesive portion 10a. Then, the holding sheet 10 is set into the cutting apparatus 1 as described above to proceed with the cutting of the pattern from the workpiece 6.

After completing all the cutting work, the user is to peel the workpiece 6 from the holding sheet 10 and subsequently attach the first partial sheet 40A and the second partial sheet 40B to the holding sheet 10. More specifically, the user is to first insert the engagement protrusions 31a and 31b of the holding sheet 10 into the engagement holes 41a and 41b of the first partial sheet 40A. The engagement protrusions 31a and 31b are provided outside the bounds of the adhesive portion 10a within the holding sheet 10. Thus, the user is to tilt or gently bend the first partial sheet 40A such that its engagement hole 41a and 41b is oriented toward the engagement protrusions 31a and 31b and insert the engagement protrusions 31a and 31b into engagement holes 41a and 41b to establish the engagement without touching the adhesive portion 10a. This engagement determines the location of the first partial sheet 40A within the holding sheet 10. Then, the user is to release the bend of the first partial sheet 40A and allow it to return to its original flat state for attachment with the adhesive portion 10a.

The engagement of the second partial sheet 40B may be carried out in the same way as the first partial sheet 40A. That is, the user may gently bend the rear side portion of removable sheet 10 in which the engagement holes 42a and 42b are formed toward the engagement protrusions 32a to 32b located in the rear side portion of the holding sheet 10 to establish the engagement. Alternatively, the user may gently bend the front side portion of removable sheet 10 in which the engagement holes 43a to 44b are formed toward the engagement protrusions 33a to 34b located in the front side portion of the holding sheet 10 to establish the engagement. The engagement locates the removable sheet 10 with respect to the holding sheet 10. Then, the user is to release the bend of the removable sheet 10 and allow it to return to its original flat state for attachment with the adhesive portion 10a. As a result, the second partial sheet 40B is attached precisely in the predetermined first position with each and every engagement holes 42a to 44b being engaged with the corresponding engagement protrusions 32a to 34b as shown in FIG. 5B. When the holding sheet 10 is not in use, the adhesive portion 10a is entirely covered with the first partial sheet 40A and the second partial sheet 40B.

As described above, the holding sheet 10 of the first embodiment comprises the adhesive portion 10a provided on at least a portion of one side of the holding sheet 10 and being configured to removably hold the workpiece 6, the removable sheet 40 covering the surface of the adhesive portion 10a, and the locators 31a to 34b and 41a to 44b provided on the holding sheet 10 and the removable sheet 40 for locating the removable sheet 40 on the adhesive portion 10a when attaching the removable sheet 40 to the adhesive portion 10a.

According to the above described configuration, when attaching the removable sheet 40 to the adhesive portion 10a of the holding sheet 10, the removable sheet 40 is located with respect to the holding sheet 10 by way of the locators 31a to 34b and 41a to 44b. Thus, the removable sheet 40 can be attached precisely to the adhesive portion 10a without dislocation. Further, because the attachment of the removable sheet 40 is facilitated, usability is improved. As will be later described in detail, providing the locators on at least either of the holding sheet and the removing sheet will provide similar effects.

The locator comprises engagement portions 31a to 34b provided on the holding sheet 10 and engagement subjects 41a to 44b provided on the removable sheet 40. The engagement subjects 41a to 44b is capable of establishing an engagement with the engagement portions 31a to 34b and when engaged, locates the removable sheet 40 on a predetermined location of the holding sheet 10.

Accordingly, the removable sheet 40 can be located on a predetermined location of the holding sheet 10 by the engagement of engagement subjects 41a to 44b of the removable sheet 40 with the engagement portions 31a to 34b provided on the holding sheet 10. Thus, the engagement of the engagement portions 31a to 34b with the engagement subjects 41a to 44b allows precise locationing of the removable sheet 40.

The holding sheet 10 includes an adhesive portion 10a located in an area inwardly spaced by a predetermined distance from the outer edge of the holding sheet 10. The holding sheet 10 is further provided with engagement portions 31a to 34b in an area located outside the adhesive region 10a. The removable sheet 40 is configured to be larger in size than the adhesive portion 10a and is provided with engagement subjects 41a to 44b on its peripheral edge.

According to the above described configuration, the engagement portions 31a to 34b are provided in the area located outside the adhesive region 10a. Thus, the removable sheet 40 may be located with respect to the adhesive portion 10a without contacting the adhesive portion 10a when engaging the engagement portions 31a to 34b with engagement subjects 41a to 44b. Further, because the removable sheet 40 is larger than the area occupied by the adhesive portion 10a, the entire adhesive portion 10a may be covered reliably.

The engagement portions 31a to 34b of the first embodiment are provided on the edge portions 103 and 104 of the peripheral edge of the holding sheet 10 exclusive of the edges held between the drive roller 12 and the pinch roller 13. Thus, the drive roller 12 will not contact the engagement portions 31a to 34b when the holding sheet 10 is moved in the first direction.

The holding sheet 10 is provided with engagement protrusions 31a to 34b which is one example of the aforementioned engagement portion. The removable sheet 40 is provided with engagement holes 41a to 44b which is one example of the aforementioned engagement subject. The engagement of the engagement protrusions 31a to 34b with the engagement holes 41a to 44b allows precise locationing of the removable sheet 40.

The removable sheet 40 comprises a plurality of divided partial sheets 40A and 40B. Under the above described configuration, the user is to cover the adhesive region 10a using all of the plurality of partial sheets 40A and 40B when the holding sheet 10 is not in use. On the other hand, when the holding sheet 10 is in use, and the shape to be cut out using the cutting apparatus 1 is relatively small, the adhesive portion 10a is covered by the attachment of the workpiece which is suitably sized relative to the shape to be cut out and by the partial sheet 40B. Thus, the adhesive portion 10a can be covered by the partial sheet 40B without exposing the adhesive portion 10a even when the holding sheet 10 is cut by being set into the cutting apparatus 1. Thus, the adhesive force of the adhesive portion 10a can be maintained without degrading.

The removable sheet 40 comprises a flat rectangular sheet. The plurality of partial sheets comprises the first partial sheet 40A and the second partial sheet 40B. The first partial sheet 40A and the second partial sheet 40B are divided by an L-shaped divisional line 45 intersecting at the center of the removable sheet 40. The first partial sheet 40A is rectangular and occupies ¼ of the size of the removable sheet. The second partial sheet 40B occupies ¾ of the size of the removable sheet 40 that is, the remaining portion of the removable sheet 40.

According to the above described configuration, when the holding sheet 10 is not in use, the user is to cover the adhesive portion 10a with the first partial sheet 40A and the second partial sheet 40B. When the holding sheet 10 is in use on the other hand, the user is to cover the adhesive portion 10a with the workpiece which is approximately the ¼ of the size of the entire removable sheet 40 and the second partial sheet 40B approximately ¾ of the size of the entire removable sheet 40, in such case, the second partial sheet 40B may be arranged in 4 different layout patterns in which the workpiece is held in 4 different areas of the adhesive portion 10a. Such arrangement allows the times of use of the holding sheet 10 to be increased. The intersection of the L-shaped divisional lines need not be located on the exact center of the removable sheet 40 but may be configured as an L-shaped line that intersects substantially at the central portion of the removable sheet 40. In such case, the plurality of partial sheets comprises a rectangular first partial sheet which is substantially ¼ of the size of the removable sheet 40 and a second partial sheet which is substantially ¾ of the size of the removable sheet 40, that is, the remaining portion of the removable sheet 40.

### Other Embodiments

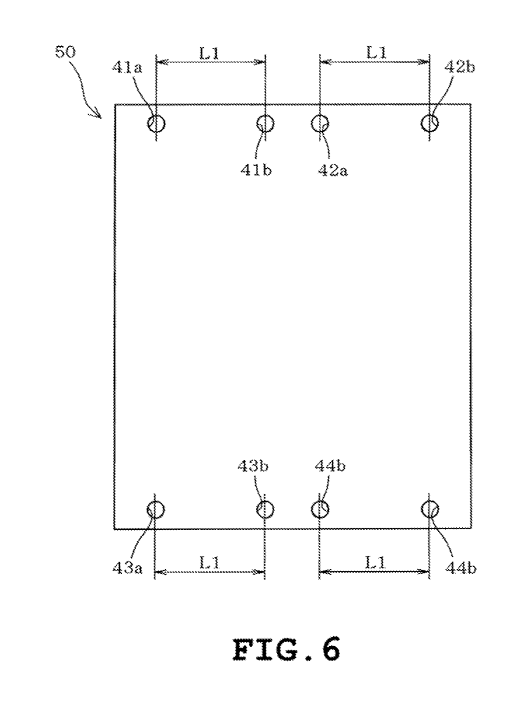

FIGS. 6 to 11 illustrate a second to a seventh embodiment and the elements that are identical to those of the first embodiment are identified with identical reference symbols and are not re-described. The following description will discuss the differences from the first embodiment.

FIG. 6 illustrates a removable sheet 50 according to a second embodiment. The removable sheet 50 differs from the removable sheet 40 of the first embodiment in that the removable sheet 50 comprises a single flat rectangular sheet which is undivided. On the peripheral edge of the removable sheet 50, engagement holes 41a to 44b are formed in locations corresponding to the engagement protrusions 31a to 34b of the holding sheet 10.

In covering the adhesive portion 10a of the holding sheet 10 with the removable sheet 50, the user is to gently bend the rear side portion of removable sheet 50 in which the engagement holes 41a to 42b are formed toward the engagement protrusions 31a to 32b located in the rear side portion of the holding sheet 10 to establish the engagement. Alternatively, the user may gently bend the front side portion of removable sheet 50 in which the engagement holes 43a to 44b are formed toward the engagement protrusions 33a to 34b located in the front side portion of the holding sheet 10 to establish the engagement. The engagement locates the removable sheet 50 with respect to the holding sheet 10. Then, the user is to release the bend of the removable sheet 50 and allow it to return to its original flat state for attachment with the adhesive portion 10a. As a result, the removable sheet 50 is attached precisely in the predetermined position for covering the entire adhesive portion 10a with each and every engagement holes 41a to 44b being engaged with the corresponding engagement protrusions 31a to 34b. Thus, the engagement of the engagement protrusions 31a to 34b to the engagement holes 41a to 44b allows precise and easy attachment of the removable sheet 50 to provide effects similar to those of the first embodiment.

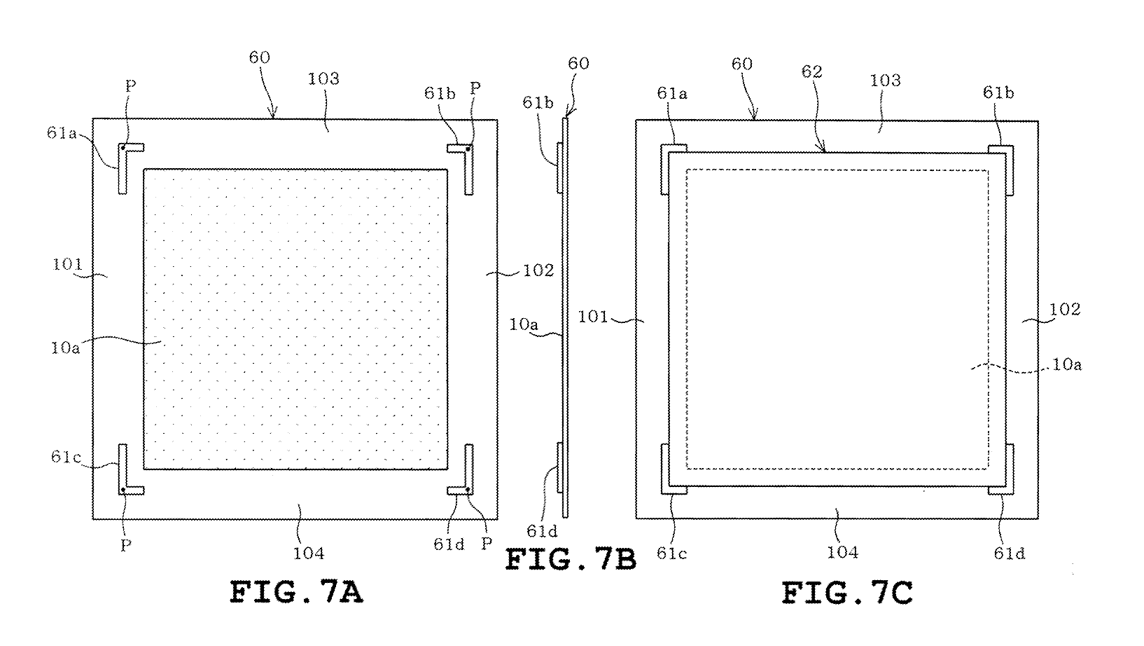

FIGS. 7A to 7C illustrate a third embodiment. The holding sheet 60 and the removable sheet 62 according to the third embodiment differ from holding sheet 10 and the removable sheet 50 of the foregoing embodiments in the following respects.

As shown in FIG. 7C, the removable sheet 62 of the third embodiment does not have any engagement holes 41a to 44b. Still referring to FIG. 7C, the removable sheet 62 comprises a flat rectangular sheet which is larger than the adhesive portion 10a

On the other hand, the peripheral edge of the holding sheet 60 of the third embodiment is provided with a plurality of contact portions 61a to 61d, instead of the engagement protrusions 31a to 34b provided in the foregoing embodiments, as one example of the locator. Though the third embodiment exemplifies 4 contact portions, the number of contact portions may be modified as appropriate. As shown in FIGS. 7A and 7B, the contact portions 61a to 61d are each formed in a shape of L extending along the corners of the adhesive portion 10a. The contact portions 61a to 61d are formed so as to protrude upward by emboss processing. Further, the contact portions 61a to 61d are located outside the adhesive portion 10a so as to surround the adhesive portion 10a. The contact portions 61a to 61d are capable of contacting the corners, in other words, the outer peripheral edge of the removable sheet 62.

In covering the adhesive portion 10a of the holding sheet 60 with the removable sheet 62, the user is to place, for instance, one side of the removable sheet 62 which is shown as the upper side in FIG. 7 in contact with the pair contact portions 61a and 61b of the holding sheet 60. At this instance, the user is to gently bend the removable sheet 62 and move the removable sheet 62 such that one side of the removable sheet 62 approximates the contact portions 61a and 61b until the 2 corners on that side of the removable sheet 62 contacts the inner side of the contact portions 61a and 61b without any portions of the removable sheet 62 touching the adhesive region 10a. The contact allows the location of the removable sheet 62 with respect to the holding sheet 60. Then, as shown in FIG. 7C, the user is to release the bend of the removable sheet 62 and allow it to return to its original flat state for attachment with the adhesive portion 10a. As a result, the removable sheet 62 is attached precisely in the predetermined position for covering the entire adhesive portion 10a with each of the corners of the removable sheet 62 resting within the corresponding contact portions 61a to 61b.

As described above, the removable sheet 62 is configured as a flat rectangular sheet and the contact portions 61a to 61d provided on the holding sheet 60 are one example of the locator capable of contacting the outer edge portions of the removable sheet 62. According to the above described configuration, the removable sheet 62 can be located with respect to the holding sheet 60 by placing the outer edge portions of the removable sheet 62 in contact with the contact portions 61a to 61d of the holding sheet 60. Thus, the locator no longer needs to be provided on the removable sheet 62. Further, the structure of the locator can be simplified by taking advantage of the shape of the removable sheet 62.

Though not shown, the contact portion may foe configured by a combination of discontinuous lines in which a discontinuity is introduced at vertex P of the L-shape shown in FIG. 7A in each of the contact portions 61a to 61d.

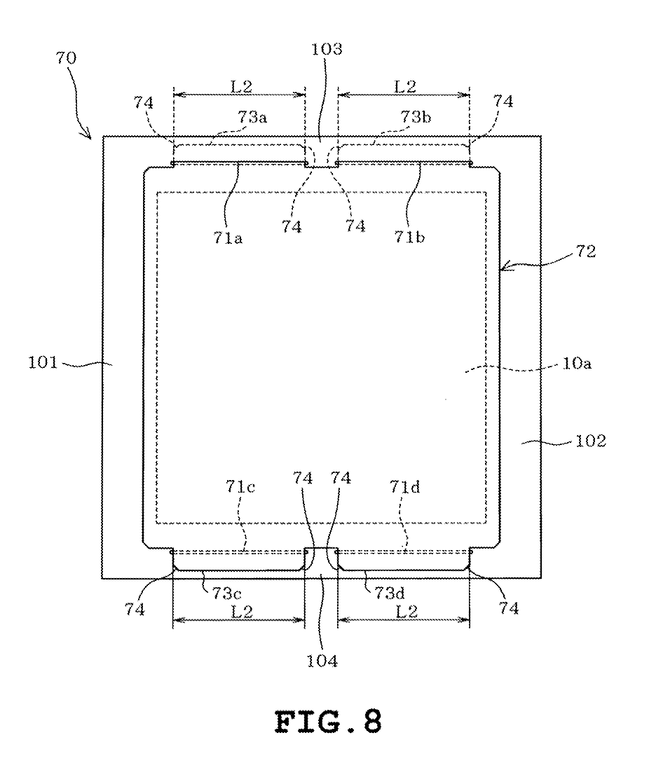

FIG. 8 illustrates a fourth embodiment. The holding sheet 70 according to the fourth embodiment includes a plurality of engagement holes 71a to 71d as one example of the engagement portion. The removable sheet 72, on the other hand, includes a plurality of engagement tongues 73a to 73d as one example of the engagement subject.

The engagement holes 71a to 71d are formed in the area of the holding sheet 70 located outside the adhesive portion 10a. The engagement holes 71a to 71d comprises a pair of elongate holes 71a and 71b extending in the length direction taken along the left and right direction of the rear end portion 103 and a pair of elongate holes 71c and 71d extending in the length direction taken along the left and right direction of the front end portion 104. Each of the engagement holes 71a to 71d extends in the thickness direction through the holding sheet 70 and extends along the periphery of the adhesive portion 10a in the form of a slit.

The removable sheet 72 generally exhibits a flat rectangular shape and is larger than the adhesive portion 10a. Further, the removable sheet 72 is provided with a pair of engagement tongues 73a and 73b protruding rearward from the rear edge portion and a pair of engagement tongues 73c and 73d protruding forward from the front edge portion. The engagement tongues 73a to 73d are structurally integral with the removable sheet 72. The engagement tongues 73a to 73d are configured to have width L2 slightly smaller than the length of engagement holes 71a to 71a. The engagement pieces 73a to 73d are symmetric in the left and right side and the front and rear side within removable sheet 72. Thus, the engagement tongues 73a to 73b are configured as engagement protrusions capable of engaging with the engagement holes 71a to 71d even when removable sheet is turned such that the left and the right side or the front and the rear side are switched over. Each of the engagement tongues 73a to 73b is provided with a slope 74 which is inclined to allow its tip to be embraced by the engagement holes 71a to 71d. Thus, the engagement tongues 73a to 73d are inserted smoothly into the engagement holes 71a to 71d by the presence of the slope 74.

In covering the adhesive portion 10a of the holding sheet 70 with the removable sheet 72, the user is to engage the engagement tongues 73a and 73b of the removable sheet 72 with the engagement holes 71a and 71b of the holding sheet 70 by, for instance, inserting the tip to the base end of the engagement tongues 73a and 73b into the engagement holes 71a and 71b from the obliquely upward direction. The engagement locates the removable sheet 72 with respect to the holding sheet 70. Then, the user is to allow the obliquely leaning removable sheet 72 to fall over toward the adhesive portion 10a to attach the removable sheet 72 to the adhesive portion 10a of the holding sheet 70. As a result, the removable sheet 62 is attached precisely in the predetermined position for covering the entire adhesive portion 10a as shown in FIG. 8. The remaining other engagement tongues 73c and 73d of the removable sheet 72 need not be engaged with the engagement holes 71c and 71d of the holdings sheet 70.

As described above, engagement holes 71a to 71d are formed on the holding sheet 70 as one example of the engagement portion and the engagement tongues 73a to 73d are formed on the removable sheet 72 as one example of the engagement subject. According to such configuration, the removable sheet 72 can be located precisely with respect to the holding sheet 70 by the locking effected by the insertion of engagement tongues 73a to 73d into the engagement holes 71a to 71d.

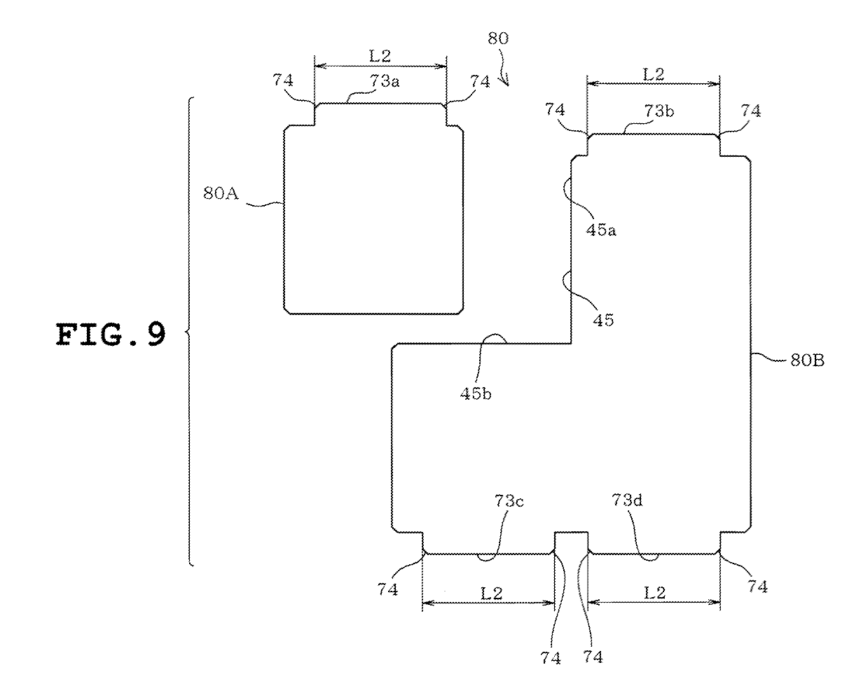

FIG. 9 illustrates a fifth embodiment. A removable sheet 80 according to the fifth embodiment differs from the removable sheet 72 of the fourth embodiment in that the removable sheet 80 is divided into a first partial sheet 80A and a second partial sheet 80B at the L-shaped divisional line 45.

The first partial sheet 80A occupies ¼ of the size of the removable sheet 80. The first partial sheet 80A is provided with a single piece of engagement tongue 73a. The second partial sheet 80B occupies ¾ of the size of the removable sheet 80, that is, the remaining portion of the removable sheet 80. The second partial sheet 80B is provided with 3 pieces of engagement tongues 73b to 73d. In covering the adhesive portion 10a of the holding sheet 70 with the first partial sheet 80A and the second partial sheet 80B, the user is to engage the engagement tongues 73a of the first partial sheet 80A with the engagement hole 71a of the holding sheet 70 by, for instance, inserting the tip to the base end of the engagement tongue 73a into the engagement hole 71a from the obliquely upward direction. The engagement locates the first partial sheet 80A with respect to the holding sheet 70. Then, the user is to allow the obliquely leaning first partial sheet 80A to fall over toward the adhesive portion 10a to attach the first partial sheet 80A to the adhesive portion 10a of the holding sheet 70. As a result, first partial sheet 80A is attached precisely in the predetermined first position

Regarding the second partial sheet 80B, the user is to similarly engage the engagement tongue 73b of the rear side portion of the second partial sheet 80B with the engagement hole 71a in the rear side portion of the holding sheet 70 by, for instance, inserting the tip to the base end of the engagement tongue 73b into the engagement hole 71a from the obliquely upward direction. Alternatively, the user is to engage the engagement tongues 73c and 73d of the front side portion of the second partial sheet 80B with the engagement holes 71c and 71d in the front side portion of the holding sheet 70 by, for instance, inserting the tip to the base end of the engagement tongues 73c and 73d into the engagement holes 71c and 71d from the obliquely upward direction. Then, the user is to allow the obliquely leaning second partial sheet 80B to fall over toward the adhesive portion 10a to attach the second partial sheet 80B to the adhesive portion 10a of the holding sheet 70. As a result, the second partial sheet 80B is attached precisely in the predetermined first position

As described above, when the holding sheet 70 is not in use, the first partial sheet 80A and the second partial sheet 80B are each attached to the adhesive portion 10a so as to cover the adhesive portion 10a. When the holding sheet 70 is in use on the other hand, the user is to cover the adhesive portion 10a with the workpiece which is approximately the ¼ of the size of the entire removable sheet 80 and the second partial sheet 80B approximately ¾ of the size of the entire removable sheet 80. As was the case in the first embodiment, 4 types of layout patterns may be established by placing the second partial sheet 80B in the first to fourth position. Such arrangement provides the effects similar to those of the first embodiment such as allowing the times of use of the holding sheet 80 to be increased.

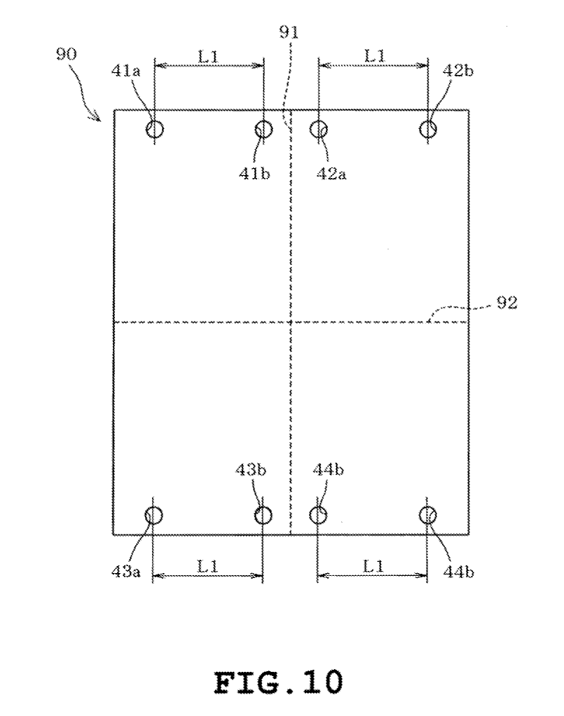

FIG. 10 illustrates a sixth embodiment.

According to the removable sheet 90 according to the sixth embodiment, a first perforated line 91 and a second perforated line 92 are provided for separating or dividing the removable sheet 90. The first perforated line 91 is formed as a straight line at the substantial widthwise center of the removable sheet 90. The width direction, in this case, is taken along the left and right direction. The second perforated line 92 is formed as a straight line at the substantial lengthwise center of the removable sheet 90. The length direction, in this case, is taken along the front and rear direction. The first perforated line 91 and the second perforated line 92 transverse the removable sheet 90 in the left and right direction and the up and down direction so as to delineate the removable sheet 90 into 4 subsections. Thus, first perforated line 91 and the second perforated line 92 intersect in a cruciform at the central portion of the removable sheet 90. Further, the regions delineated by the perforated lines 91 and 92 contain either of the engagement holes 41a to 44b.

When cutting a small size workpiece, the user may separate the left-side rear half portion of the removable sheet 90 along the perforated lines 91 and 92 so as to leave an L-shaped edge. This allows the removable sheet 90 to be used as a partial sheet as was the case in the removable sheet 40 of the first embodiment as can be seen in FIGS. 4 and 10. The removable sheet 90 may be left unseperated at the perforated lines 91 and 92 in which case the removable sheet 90 may be utilized as the removable sheet 50 of the second embodiment as can be seen in FIGS. 6 and 10. The removable sheet 90 may be bisected into a left side subsection and a right side subsection along the first perforated line 91 or may be bisected into a front side subsection and a rear side subsection along the second perforated line 92. Even when the removable sheet 90 is separated into 4 subsections each of the partial sheets can still be located with respect to the adhesive portion 10a by utilizing the engagement holes 41a to 44b of the partial sheets.

As described above, the removable sheet 90 is provided with at least one perforated line. In this example, lines 91 and 92 taken together represent one perforated line. According to such configuration, the removable sheet 90 can be neatly separated along the perforated lines 91 and 92. Thus, the user is allowed to separate the removable sheet 90 into partial sheet of various sizes suitable for the workpiece to be cut.

The foregoing embodiments described and shown may be modified or expanded as follows.

The features described in the foregoing embodiments are not limited to application to a cutting plotter represented as the cutting apparatus 1 but may be applied to other types of apparatuses provided with a cutting function.

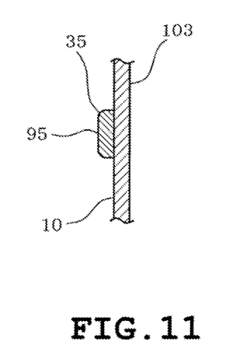

The configuration of locator is not limited to the examples described in the foregoing embodiments but may be modified to vary the shape, number, and layout of the engagement protrusion, engagement hole, and the contact portions. For instance, the first embodiment may be modified such that the engagement protrusions 31a to 34b of the holding sheet 10 are replaced by an engagement protrusion 95 shown in FIG. 11. The engagement protrusion 95 shown in FIG. 11 is shaped as a small cylinder. The engagement protrusion 95 is secured on the holding sheet 10 with an adhesive.

Further, the removable sheet 40 may be provided with engagement protrusions 31a to 34b or the engagement protrusion 95 to serve as the engagement subject. In such case, the holding sheet 10 is provided with the engagement holes 41a to 44b to serve as the engagement portion. Such configuration will also provide effects similar to the first embodiment.

The term “perforated line” is used in the foregoing embodiments to encompass holes or silts formed intermittently in a perforated manner for allowing the separation of the removable sheet. The perforated lines 91 and 92 may be formed selectively. A plurality of additional perforated lines may be formed on the removable sheet to form partial sheets of various shapes. In the third embodiment, the removable sheet 62 is configured so as not to require the engagement subject. However, the above described perforated lines 91 and 92 may be formed on the removable sheet 62.

In the foregoing embodiment, the holding sheet and the adhesive portion have been exemplified to exhibit a generally rectangular shape. Further, the adhesive portion 10a may be formed on the entire upper surface of the holding sheet. In such case, a thin sheet of metal or resin may be applied on a portion corresponding to the lefts side edge portion or the right side edge portion to serve as a support subject.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

What is claimed is:

1. A holding sheet comprising:
an adhesive portion disposed on at least a part of either one of surfaces of the holding sheet, wherein the adhesive portion is configured to attach to a workpiece;
a removable sheet configured to be attached to the adhesive portion; and
a locator disposed on at least either the holding sheet or the removable sheet, and configured to attach the removable sheet to the adhesive portion in a predetermined location.

2. The holding sheet according to claim 1,
wherein, the locator comprising:
a first engagement portion disposed on the holding sheet; and
a second engagement portion disposed on the removable sheet, wherein the first engagement portion is configured to engage with the second engagement portion,

3. The holding sheet according to claim 2,
wherein the adhesive portion is disposed on an area within the holding sheet, the adhesive portion is spaced inward by a pre-determined distance from an peripheral edge of the holding sheet,
wherein the first engagement portion is disposed on an outer area of the adhesive portion,
wherein the removable sheet is larger than an area of the adhesive portion, and
wherein the second engagement portion is disposed on a peripheral edge of the removable sheet.

4. The holding sheet according to claim 2,
wherein the first engagement portion is an engagement protrusion, and
wherein the second engagement portion is an engagement hole.

5. The holding sheet according to claim 2,
wherein the first engagement portion is an engagement hole, and
wherein the second engagement portion is an engagement protrusion.

6. The holding sheet according to claim 1,
wherein the removable sheet is a flat rectangular sheet,
wherein the locator is disposed on the holding sheet, and the locator is a contact portion configured to be contactable to an outer edge of the removable sheet.

7. The holding sheet according to claim 1,
wherein the removable sheet comprising:
a plurality of partial sheets.

8. The holding sheet according to claim 7,
wherein the removable sheet is a flat rectangular sheet, and
wherein the plurality of partial sheets comprising:
a first partial sheet and a second partial sheet,
wherein the first partial sheet and the second partial sheet are configured to be separable at an L-shaped divisional line intersecting at the center of the removable sheet.

9. The holding sheet according to claim 8,
wherein the first partial sheet occupies ¼ of the size of the removable sheet, and
wherein the second partial sheet occupies ¾ of the size of the removable sheet.

10. The holding sheet according to claim 1,
wherein the removable sheet comprising:
at least one perforated line.

11. A cutting apparatus comprising:
a cutter configured to cut a workpiece; and
a holding sheet,
wherein the holding sheet comprising:
an adhesive portion disposed on at least a part of either one of surfaces of the holding sheet, wherein the adhesive portion is configured to attach to a workpiece;
a removable sheet configured to be attached to the adhesive portion; and
a locator disposed on at least either the holding sheet or the removable sheet, and configured to attach the removable sheet to the adhesive portion in a predetermined location.
